(19) United States
(12) Patent Application Publication
(10) Pub. No.: US 2012/0303547 A1
(43) Pub. Date: Nov. 29, 2012

(54) RISK ASSESSMENT PROCESSES FOR CLOSEOUT OF A PORTFOLIO

(75) Inventor: Luis Antônio Barron Guerra Vicente, Vinhedo - SP (BR)

(73) Assignee: BM&F BOVESPA S.A. - BOLSA DE VALORES, MERCADORIAS E FUTUROS, Sao Paulo - SP (BR)

(21) Appl. No.: 13/462,091

(22) Filed: May 2, 2012

Related U.S. Application Data
(60) Provisional application No. 61/481,473, filed on May 2, 2011.

(51) Int. Cl. G06Q 40/06

(52) U.S. Cl. 705/36 R

(57) ABSTRACT

The invention pertains, in a general manner, to a process of risk assessment for closing out a portfolio and, more specifically, the invention relates to processes that allow a more efficient capital allocation for containing such risks. According to an embodiment of the invention, the risk assessment process for the closeout of a portfolio comprises the steps of (i) identifying a portfolio to be closed out; (ii) defining a strategy for the closeout of mentioned portfolio; (iii) estimating the risk related to the closeout strategy; and (iv) determining the potential losses for closing out the mentioned portfolio based on the evaluated risk.

### RELATED APPLICATIONS

This application claims the benefit under 35 U.S.C. 119(e) to U.S. Provisional Patent Application Ser. No. 61/481,473, filed May 2, 2011, entitled Methods and Systems to Estimate a Risk, which is incorporated herein by reference in its entirety and made a part hereof.

### TECHNICAL FIELD

The invention relates, in a general manner, to processes and system of risk assessment for closing out a portfolio and, more specifically, the invention relates to processes and system that allow a safer transaction and, at the same time, with lower risk and costs for at least one of the parties involved in the transaction.

### DEFINITIONS

For the present specification and interpretation of the accompanying claims, the following definitions have been adopted:
Instruments: assets and financial contracts negotiated or registered, directly or indirectly, in a negotiation and/or registry environment, including, but not limited to, Exchanges and their spot or derivative markets (futures, forward and options markets), that have as their subject or reference shares, foreign exchange contracts, commodities, debentures, derivatives, government bonds, investment fund quotas, investment certificates, indices, indicators, rates, merchandises, and other goods or rights directly or indirectly related to said assets and contracts, in the spot or future liquidation modalities.
Collateral: contracts, assets or any other goods, values, documents or bonds, pledged by the Participants to the Central Counterparty or to other Participants with the aim of assuring fulfillment of the obligations resulting from trades negotiated at an Exchange or in other trading environments.
Exchange: entity authorized to manage organized markets (including stock, derivatives and organized over-the-counter markets), in whose real or virtual environment trading is registered and/or carried out involving any kinds of securities or contracts that have Instruments as reference or subject. Trading can be carried out by conventional means, such as onsite auction in which people gather at a physical place to trade directly with each other, or by electronic devices, whereby a buyer, for example, through a broker, negotiates the purchase of Instruments available on the market, which are sold by the sellers, for example, also through their brokers, by way of electronic communication terminals. Registration and negotiation need not necessarily to be tied to the same environment.
Clearing House: institution providing services of clearance and liquidation of operations carried out at an Exchange or in other trading environments which has as main functions, among others: (i) clearance and liquidation of obligations, as well as assessment of the risk arising from them; (ii) provide, receive and manage guarantees for the operations negotiated; and (iii) provide custodial services for the Participants of the markets. The clearing house activity can be performed by an Exchange.
Central Counterparty (CCP): entity which mediates negotiations involving Instruments, becoming the buyer of each selling Participant and the seller of each buying Participant, guaranteeing the due performance of the negotiation with each Participant. The function of the CCP can be performed by an autonomous entity, by an Exchange or by a clearing house.
Participants: individuals or legal entities acting directly or indirectly in the process of trading, registry and liquidation of operations at an Exchange or in other trading and registration environments, including, but not limited to, brokerage houses, distributors, special operators, Clearing House members, and individuals as clients.
Offer: act whereby the financial intermediary materializes its interest to negotiate by issuing a purchase or sale order of Instruments.

### BACKGROUND

Exchanges are entities that maintain electronic systems in which the trading of financial Instruments is carried out, such as assets, commodities, options, foreign exchange, etc., either by conventional means, such as an onsite auction in which people gather at a physical place to trade directly with each other, or by electronic means, whereby a buyer, through a broker, negotiates the purchase of Instruments available on the market, which are sold by sellers, also through their brokers, by way of electronic communication terminals.

In other words, Exchanges can roughly be defined as centralizers of purchase and sale negotiations in the financial and capital markets, concentrating the purchase and sale offers and demands, wherein its operation is generally subject to regulation and approval from a regulatory agent.

Other functions can also be carried out by an Exchange, such as developing, organizing and operating free and transparent markets for the trading of securities and/or contracts that have as reference financial assets, indexes, indicators, rates, commodities, currencies, etc.

Besides these functions, Exchanges can also carry out activities such as registration, clearance and financial liquidation of the operations carried out in its trading environments, acting as clearing houses.

Accordingly, electronic processes and systems have been implemented at the world's main Exchanges with the aim of assuring due performance of the obligations undertaken through the operations occurred on their exchange floors and/or registered in any systems of trading, registration, clearance and liquidation, and, consequently, enabling transactions to be carried out at a global level with greater speed and security.

Exchanges may equally take on the role of Central Counterparties (or CCP), that is, acting as interface between the counterparties of a transaction, becoming, on the one hand, the buyer of each seller and, on the other hand, the seller of each buyer. In this scenario, the responsibility of the party involved in the trading (be it buyer or seller) for the operationalization and payment of the credit object of the transaction negotiated is transferred to the CCPs.

Therefore, the credit risk perceived by the Participants is no longer associated to the trading parties and is assumed by the CCP. The homogenization of the credit risks by the CCP has advantages concerning liquidation and payment of the obligations, which are guaranteed by adopting safeguard structures that enable assured liquidation of the obligations with its Participants, even if one or more Participants default. Besides the guarantee of payment of the obligations, there is a reduction in replacement costs associated to the default process.

FIG. 1 schematically discloses the structure of a negotiation in which the Exchange acts as a CCP for an operation in which the Instrument is physically delivered. On the one hand, there is a seller, who delivers the Instrument and the Exchange makes the payment for the sale of that Instrument. On the other hand, the buyer makes the payment for the purchase and the Exchange delivers the Instrument to the buyer.

To minimize risks and to guarantee the due performance of the obligations, the Exchange, acting as CCP, adopts safeguard structures, and various models relating to these risk management structures can be applied, involving different liquidation strategies. Among these safeguard structures, the Exchange may perform a risk assessment and demand the deposit of guarantees (Collaterals).

Good risk management of a CCP is intricately linked to the efficient determination of risk for the closeout of a portfolio of Instruments. This liquidation strategy can be static, that is, defined previously and maintained until the end of the closeout process, or dynamic, when it is re-appraised in accordance with current market conditions.

FIG. 2 exemplarily depicts three different scenarios (scenarios A, B, C) of the variation in market value of an Instrument, wherein its value in T+0 is $100. From a traditional approach, the adjusted market risk, scenario C depicts the greatest potential loss for the portfolio during the analyzed period, since the price of the Instrument rises 4.43%. However, if the liquidation of this Instrument is fractionated, that is, if the purchase or sale of this Instrument is made during the projected period (T+0 to T+4), the greatest risk scenario may vary. For example, if a fractioned purchase is made at 5 units per day, closing the totality of the short position in 4 days (T+4), the result obtained in which scenario B represents greatest risk, but it still is lower than the strategy of total liquidation on the fourth day (T+4). On the other hand, if the closeout was fractioned in two days (T+1 and T+2), the greatest potential loss would be given by scenario A.

Heterogeneous portfolios, containing Instruments traded on different markets, involve the use of complex liquidation strategies based on the greatest number of variables and contour conditions involved, that is, different liquidation cycles, minimum liquidation horizons and contingent cash flow.

Exchanges, acting as CCPs, generally adopt as a risk management premise the immediate need for monetization of all the guarantees at the present time (T+0). This may generate the need for the Participant to decrease his position or transfer highly liquid Collaterals in order to preserve the premise of immediate monetization of all the guarantees. However, this premise is not efficient from the point of view of both the Participant and the Exchange. Considering, for example, the case for the closeout of a portfolio which contains: (i) options listed with maturity in one year, whose liquidation horizon is 2 days (T+2) and potential loss equal to $100M; (ii) position purchased in a swap with maturity date in two years, whose liquidation horizon is 15 days (T+15) and potential loss equal to $150M; and (iii) has Collaterals in the form of shares, already with their due haircuts, in the amount of $250M with liquidation in three days (T+3). Based on the premise of the immediate need for monetization of all the guarantees, there will be a liquidity deficit, since the Collaterals portfolio which covers the risk of potential loss cannot be readily monetized, and the immediate need of liquidity is $250M.

Thus, the Participant would transfer highly liquid Collaterals as a way of preserving the premise of immediate monetization of all the guarantees. Though simple and robust, this approach is inefficient, because, as it can easily be noted, there is a need for short-term liquidity of $100M, relating to the position in options (liquidation horizon of two days (T+2)) which cannot be met by the immediate sale of Collaterals (shares in (T+3)). The long swap operation, on the other hand, has a greater liquidation horizon than the one needed for monetization of the Collaterals (T+15 vs. T+3). According to this reasoning, the need for an immediate transfer would be $100M, and there would be no need for a transfer to the swap position purchased, since the Collateral would cover the position in T+15. The $150M remaining and dispensable for monetization allows the Participant to increase its position and, even so, continue using the shares as Collateral.

The invention therefore aims to overcome this and other shortcomings in relation to existing risk models.

### SUMMARY

One embodiment of the invention refers to a process of risk assessment for the closeout of a portfolio, which comprises the steps of:

(i) identifying a portfolio to be closed out;

(ii) defining a strategy for the closeout of said portfolio;

(iii) estimating the risk related to the closeout strategy; and

(iv) determining the potential losses for closing out said portfolio based on the estimated risk.

According to alternative or additional embodiments of the invention, the following characteristics alone or in combination may be comprised:
the step of identifying a portfolio comprises identifying a portfolio of Instruments and a portfolio of Collaterals associated with the portfolio of Instruments.
the step of defining the closeout strategy comprises selecting one or more parameters from among (a) the type(s) of Instrument(s) and/or Collateral(s) of which the portfolio is comprised; (b) the quantity of each Instrument and/or Collateral(s) of the portfolio; (c) the maturity or settlement date of each Instrument and/or Collateral(s); (d) the amount at which each Instrument and/or Collateral(s) is being negotiated; and (e) the market ability to absorb the Instrument and/or Collateral(s).
the step of defining the closeout strategy comprises determining a matrix (XE) which comprises in its rows the amount (q) of Instruments and/or Collateral that should be liquidated and, in its columns, each time interval (T) considered within a maximum term (Tₘₐₓ) for the closeout of the portfolio.
the step of defining a closeout strategy comprises additionally determining a matrix which exhibits the remaining balances of each Instrument or Collateral at each time interval considered, in accordance with:

$${s}_{i , j} = {\prod }_{i} - {\sum }_{m = 0}^{j} {q}_{i , m}$$

wherein s_{i,j} is the remaining balance of a given Instrument and/or Collateral at a given fixed time; π represents the i-th initial position of the portfolio considered, with 1≦i≦N Instruments and 0≦j≦Tmax.
the time interval considered involves constant, hourly, daily, weekly or monthly cycles.
the risk estimate step comprises an estimate of possible losses or gains relating to each period considered for a set of associated scenarios.
the risk estimate step comprises a risk calculation methodology in accordance with a predefined model.
the risk estimate step comprises determining a payoff matrix, in accordance with: CR(XE; Ω)(Π))=XR
   wherein CR is the function for determining the losses or gains; XE is the closeout strategy adopted; Ω is the function of the scenarios associated to the portfolio; π is the portfolio considered and XR is the payoff matrix.
the matrix XR is filled out with the potential values of losses and gains in each time period considered (v_{N,T}), wherein each loss or gain element (v_{i,j}) of the matrix can be determined in accordance with:

$${v}_{i , j} = {\sum }_{m = 1}^{NAT} {V}_{m} ( {s}_{m , j} ; {q}_{m , j} ; Ω ( {\prod }_{m} ; i ; j ) )$$

wherein v_{i,j} represents the loss (v_{i,j}<0) or gain (v_{i,j}>0) associated to the i-th scenario in the j-th time period (T) considered, and Vₘ is the cash flow function associated to the maintenance (s_{m,j}) or liquidation (q_{m,j}) of the position of the m-th component of the portfolio.
calculating potential losses comprise calculating the permanent losses.
calculating the permanent losses is carried out by the algebraic sum of the losses and gains in each one of the time periods (T₀, Tₘₐₓ) considered, in accordance with:

$${RP}_{i} = Min ( {\sum }_{j = 0}^{TMAX} {v}_{i , j} ; 0 )$$

wherein RPᵢ is the risk associated to the permanent loss and represents the loss (v_{i,j}<0) or gain (v_{i,j}>0) associated to the i-th scenario in the j-th time period (T) considered.
determining potential losses further comprises calculating the transient losses.
calculating transient losses comprises considering the rules for using liquidity mechanisms, in accordance with:

$${ML}_{i} = Min ( {\sum }_{j = 0}^{TMAX} {v}_{i , j} ; 0 ) - Min ( \begin{matrix}0 ; {v}_{i , 0} ; {v}_{i , 1} + {v}_{i , 2} ; \\ {v}_{i , 1} + {v}_{i , 2} + {v}_{i , 3} ; … ; {\sum }_{j = 0}^{TMAX} {v}_{i , j}\end{matrix} )$$

$${ML}_{i} \geq 0$$

wherein MLᵢ is the value of the is the value of the largest liquidity need, the last term on the right-hand side represents the estimated losses based on a self-financeable model and the first term on the right-hand side represents the estimated losses based on a full financing model.
the potential transient loss is given by:

RTᵢ=−MLᵢ+Λ(MLᵢ)

wherein RTᵢ is the value of the potential transient loss, ML is defined according to claim 15 and Λ is the function of the financing model adopted.
calculating the potential losses is the algebraic sum of the potential permanent and transient losses.
the process further comprises the step of verifying whether the Collateral deposited is sufficient (105), based on the calculation of the potential losses.
the process further comprises the step of requesting additional Collateral, if it is verified that the existing Collateral is not sufficient.

One embodiment of the invention also refers to a process for closing out a portfolio, which comprises the steps of:

(i) identifying a portfolio to be closed out;

(ii) defining a strategy for the closeout of said portfolio;

(iii) estimating the risk related to the closeout strategy; and

(iv) determining the potential losses for closing out said portfolio based on the estimated risk; and

(v) closing out the portfolio based on the strategy defined in step (ii).

According to alternative or additional embodiments of the process of closing out a portfolio, the following characteristics alone or in combination may be comprised:
the step of identifying a portfolio comprises identifying a portfolio of Instruments and a portfolio of Collaterals associated to the portfolio of Instruments.
the step of defining the closeout strategy comprises selecting one or more parameters from among (a) the type(s) of Instrument(s) and/or Collateral(s) of which the portfolio is comprised; (b) the quantity of each Instrument and/or Collateral(s) of the portfolio; (c) the maturity or settlement date of each Instrument and/or Collateral(s); (d) the amount at which each Instrument and/or Collateral(s) is being negotiated; and (e) the market ability to absorb the Instrument and/or Collateral(s).
the step of defining the closeout strategy comprises determining a matrix (XE) which comprises in its rows the amount (q) of Instruments and/or Collateral that should be liquidated and, in its columns, each time interval (T) considered within a maximum term (Tₘₐₓ) for the closeout of the portfolio.
the step of defining a closeout strategy comprises additionally determining a matrix which exhibits the remaining balances of each Instrument or Collateral at each time interval considered, in accordance with:

$${s}_{i , j} = {\prod }_{i} - {\sum }_{m = 0}^{j} {q}_{i , m}$$

wherein s_{i,j} is the remaining balance of a given Instrument and/or Collateral at a given fixed time; π represents the i-th initial position of the portfolio considered, with 1≦i≦N Instruments and 0≦j≦Tmax.
the time interval considered involves constant, hourly, daily, weekly or monthly cycles.
the risk estimate step comprises an estimate of possible losses or gains relating to each period considered for a set of associated scenarios.
the risk estimate step comprises a risk calculation methodology in accordance with a predefined model.
the risk estimate step comprises determining a payoff matrix, in accordance with:

CR(XE; Ω)(Π))=XR

wherein CR is the function for determining the losses or gains; XE is the closeout strategy adopted; Ω is the function of the scenarios associated to the portfolio; π is the portfolio considered and XR is the payoff matrix.
the matrix XR is filled out with the potential values of losses and gains in each time period considered (v_{N,T}), wherein each loss or gain element (v_{i,j}) of the matrix can be determined in accordance with:

$${v}_{i , j} = {\sum }_{m = 1}^{NAT} {V}_{m} ( {s}_{m , j} ; {q}_{m , j} ; Ω ( {\prod }_{m} ; i ; j ) )$$

wherein v_{i,j} represents the loss (v_{i,j}<0) or gain (v_{i,j}>0) associated to the i-th scenario in the j-th time period (T) considered, and Vₘ is the cash flow function associated to the maintenance (s_{m,j}) or liquidation (q_{m,j}) of the position of the m-th component of the portfolio.
calculating potential losses comprise calculating the permanent losses.
calculating the permanent losses is carried out by the algebraic sum of the losses and gains in each one of the time periods (T₀, Tₘₐₓ) considered, in accordance with:

$${RP}_{i} = Min ( {\sum }_{j = 0}^{TMAX} {v}_{i , j} ; 0 )$$

wherein RPᵢ is the risk associated to the permanent loss and v_{i,j} represents the loss (v_{i,j}<0) or gain (v_{i,j}>0) associated to the i-th scenario in the j-th time period (T) considered.
determining potential losses further comprises calculating the transient losses.
calculating transient losses comprises considering the rules for using liquidity mechanisms in accordance with:

$${ML}_{i} = Min ( {\sum }_{j = 0}^{TMAX} {v}_{i , j} ; 0 ) - Min ( \begin{matrix}0 ; {v}_{i , 0} ; {v}_{i , 1} + {v}_{i , 2} ; \\ {v}_{i , 1} + {v}_{i , 2} + {v}_{i , 3} ; … ; {\sum }_{j = 0}^{TMAX} {v}_{i , j}\end{matrix} )$$

$${ML}_{i} \geq 0$$

wherein MLᵢ is the value of the largest liquidity need, the last term on the right-hand side represents the estimated losses based on a self-financeable model and the first term on the right-hand side represents the estimated losses based on a full financing model.
the potential transient loss is given by:

RTᵢ=MLᵢ+Λ(MLᵢ)

wherein RTᵢ is the value of the potential transient loss, ML is defined according to claim 15 and Λ is the function of the financing model adopted.
calculating the potential losses is the algebraic sum of the potential permanent and transient losses.
the process further comprises the step of verifying whether the Collateral deposited is sufficient, based on the calculation of the potential losses.
the process further comprises the step of requesting coverage of the Collateral, if it is verified that the Collateral is not sufficient.

One embodiment of the invention also refers to a process for determining the closeout strategy of a portfolio, which comprises the steps of:

(i) identifying a portfolio to be closed out;

(ii) defining a strategy for the closeout of said portfolio;

wherein the strategy defining step comprises selecting one or more parameters from among (a) the type(s) of Instrument(s) of which the portfolio is comprised; (b) the quantity of each Instrument of the portfolio; and (c) the maturity or settlement date of each Instrument; and

determining a matrix (XE) which comprises in its rows the amount (q) of Instruments and/or Collateral that should be liquidated and, in its columns, each time interval (T) considered within a maximum term (Tₘₐₓ) for the closeout of the portfolio, based on the parameters associated.

According to alternative or additional embodiments of the processes for determining the closeout strategy of a portfolio, the following characteristics alone or in combination may be comprised:
the step of identifying a portfolio also comprises identifying a Participant related to said portfolio.
the step of identifying a portfolio comprises identifying a portfolio of Instruments and a portfolio of Collaterals of a Participant.

One embodiment of the invention also refers to a process of estimating the potential losses of a portfolio to be closed out, which comprises the steps of:

(i) identifying a portfolio to be closed out;

(ii) defining a strategy for the closeout of said portfolio;

(iii) estimating the risk related to the closeout strategy; and

(iv) determining the potential losses for closing out said portfolio based on the estimated risk, wherein the potential losses comprise determining the permanent losses and the transient losses.

According to alternative or additional embodiments of the process of estimating the potential losses of a portfolio to be closed out, the following characteristics, alone or in combination may be comprised:
the step of identifying a portfolio comprises identifying a portfolio comprises identifying a portfolio of Instruments and a portfolio of Collaterals associated to the portfolio of Instruments.
the step of defining a closeout strategy comprises selecting one or more parameters from among (a) the type(s) of Instrument(s) and/or Collateral(s) of which the portfolio is comprised; (b) the quantity of each Instrument and/or Collateral(s) of the portfolio; (c) the maturity or settlement date of each Instrument and/or Collateral(s); (d) the amount at which each Instrument and/or Collateral(s) is being negotiated; and (e) the market ability to absorb the Instrument and/or Collateral(s).
the step of defining a closeout strategy comprises determining a matrix (XE) which comprises in its rows the amount (q) of Instruments and/or Collateral that should be liquidated and, in its columns, each time interval (T) considered within a maximum term (Tₘₐₓ) for the closeout of the portfolio.
the step of defining a closeout strategy comprises additionally determining a matrix which exhibits the remaining balances of each Instrument or Collateral at each time interval considered, in accordance with:

$${s}_{i , j} = {Π}_{i} - {\sum }_{m = 0}^{j} {q}_{i , m}$$

wherein s_{i,j} is the remaining balance of a given Instrument and/or Collateral at a given fixed time; π represents the i-th initial position of the portfolio considered, with 1≦i≦N Instruments and 0≦j≦Tmax.
the time interval considered involves constant, hourly, daily, weekly or monthly cycles.
the risk estimate step comprises an estimate of possible losses or gains relating to each period considered for a set of associated scenarios.
the risk estimate step comprises a risk calculation methodology in accordance with a predefined model.
the risk estimate step comprises determining a payoff matrix, in accordance with:

CR(XE; Ω(Π))=XR

wherein CR is the function for determining the losses or gains; XE is the closeout strategy adopted; Ω is the function of the scenarios associated to the portfolio; π is the portfolio considered and XR is the payoff matrix.
the matrix XR is filled out with the potential values of losses and gains in each time period considered (v_{N,T}), wherein each loss or gain element (v_{i,j}) of the matrix can be determined in accordance with:

$${v}_{i , j} = {\sum }_{m = 1}^{NAT} {V}_{m} ( {s}_{m , j} ; {q}_{m , j} ; Ω ( {Π}_{m} ; i ; j ) )$$

wherein v_{i,j} represents the loss (v_{i,j}<0) or gain (v_{i,j}>0) associated to the i-th scenario in the j-th time period (T) considered, and Vₘ is the cash flow function associated to the maintenance (s_{m,j}) or liquidation (q_{m,j}) of the position of the m-th component of the portfolio.
calculating the permanent losses is carried out by the algebraic sum of the losses and gains in each one of the time periods (T₀, Tₘₐₓ) considered, in accordance with:

$${RP}_{i} = Min ( {\sum }_{j = 0}^{TMAX} {v}_{i , j} ; 0 )$$

wherein RPᵢ is the risk associated to the permanent loss and v_{i,j} represents the loss (v_{i,j}<0) or gain (v_{i,j}>0) associated to the i-th scenario in the j-th time period (T) considered.
calculating transient losses comprises considering the rules for using liquidity mechanisms, in accordance with:

$${ML}_{i} = Min ( {\sum }_{j = 0}^{TMAX} {v}_{i , j} ; 0 ) - Min ( \begin{matrix}0 ; {v}_{i , 0} ; {v}_{i , 1} + {v}_{i , 2} ; \\ {v}_{i , 1} + {v}_{i , 2} + {v}_{i , 3} ; … ; {\sum }_{j = 0}^{TMAX} {v}_{i , j}\end{matrix} )$$

$${ML}_{i} \geq 0$$

wherein MLᵢ is the value of the greatest need for liquidity, the last term on the right-hand side represents the estimated losses based on a self-financeable model and the first term on the right-hand side represents the estimated losses based on a full financing model.
the potential transient loss is given by:

RTᵢ=−MLᵢ+Λ(MLᵢ)

wherein RTᵢ is the value of the potential transient loss, ML is defined according to claim 15 and Λ is the function of the financing model adopted.

### BRIEF DESCRIPTION OF THE DRAWINGS

The invention will now be described in relation to particular embodiments, with reference to the accompanying drawings, provided for the purpose of illustrating the invention. Said drawings are schematic and may not fully correspond to certain implementations, since they are merely intended to illustrate the invention in an exemplarily way, without imposing any limitations other than those defined in the claims further ahead, wherein:

FIG. 1 is a schematic diagram of an Exchange acting as a CCP;

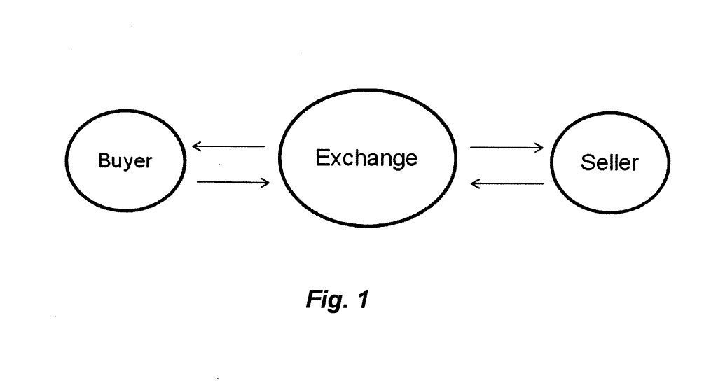

FIG. 2 is an exemplary graph of scenarios related to different liquidation strategies of a portfolio;

FIG. 3 is an exemplary flowchart of a method according to a process embodiment of the invention; and

FIG. 4 is a block diagram of a risk management system according to a system embodiment of the invention.

### DESCRIPTION OF PARTICULAR EMBODIMENTS

The invention is now described in relation to one or more particular exemplary embodiments. In the description of the exemplary embodiment set forth ahead, a process and system of the invention are considered and applied in an Exchange environment. However, as those skilled in the art may realize, the processes of the invention may be applied to risk assessment or closeout of a portfolio in any environment that involves a portfolio of Instruments and, potentially, Collaterals, such as, but not limited to, banks, brokerage houses, consortia, or other financial, private or public institutions.

Therefore, according to a process of the invention, it is possible to improve the risk assessment involved in the closeout of a portfolio by optimizing the requirement of guarantees (Collaterals), either in an Exchange environment, or any other environment that involves a portfolio of investments.

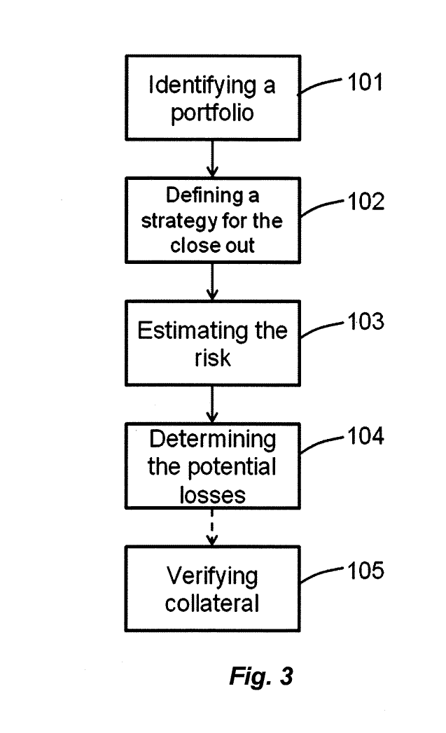

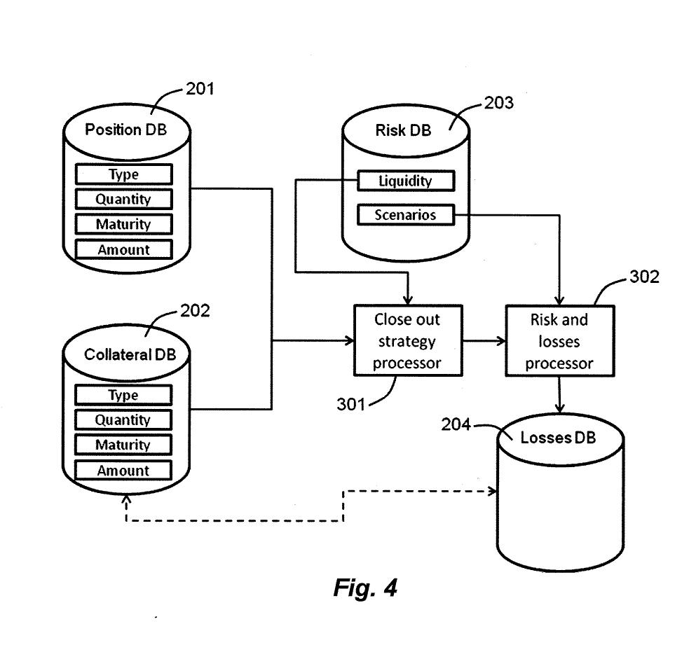

The following example process is described with reference to the operations included in the flowchart of FIG. 3, and the data storage and processing elements of a risk management system included in the block diagram of FIG. 4. The process begins by identifying a portfolio to be closed out (operation 101). The portfolio of a certain market Participant in an Exchange or other regulated environment comprises his/her transactions, that is, the Instruments being traded by that Participant. Such portfolio of a Participant is recorded for instance in a position database (201). Generally, the Exchange includes one or more databases which records reflecting, tracking and/or recording the transactions undertaken by the Participant and/or the results thereof. Such database(s) (for example the position database (201)) are updated accordingly to reflect those transactions and/or positions of the Participant, therefore allowing the Exchange to audit, account for, and manage the activity associated with a Participant. As further discussed herein, such position records registered in the database (such as the position database (201)) may include data related to the type, quantity, maturity, and amount of the positions.

Additionally, the Participant may also provide Collaterals as guarantees for payment of its trading, referred to herein as Collaterals portfolio. The Collaterals of a Participant are also registered in a database (such as a Collateral database (202)), which maintains records of the Collaterals deposited or Instruments given as guarantee by the Participant. As further discussed herein, such Collateral records registered in the database (such as the Collateral database (202)) may include data related to the type, quantity, maturity, and amount of the Collaterals.

In conventional models of risk assessment, only the portfolio of Instruments is considered for the closeout strategy, and not the Collaterals.

According to the invention, in a particular embodiment, identifying the portfolio to be closed out comprises identifying both the Instruments and the Collaterals for the risk assessment of the closeout of the portfolio. Therefore, the identification of the portfolio and its composition can be carried out by identifying the positions and transactions carried out by the Participant in the position database (201), since an Exchange or any other financial institution, within a regulated information system, readily provides the data and information on Participants and the trading by these Participants, as well as data and information on the Collaterals deposited by the Participants trough the Collateral database (202). For example purposes, the process and system described herein are related to one Participant only, but naturally, a plurality of Participants may be used, individually or jointly.

Next is the definition of the closeout strategy of the portfolio (operation 102), which includes determining the most efficient manner of liquidating the positions of the Participant, for example, but without limitation, by way of trading the reverse position, liquidation by maturity or positions transfer.

In order to define the closeout strategy, within the determination of the most efficient manner of liquidating the Participant's positions and eventually also the Collaterals, one or more of the following parameters can be taken into consideration:
(a) the type(s) of Instrument(s) and/or Collateral of which the portfolio is comprised. The portfolio to be considered should preferably comprise both the Instruments and the Collaterals, and it is important to check the type of each Instrument and Collateral comprised in the portfolio, such as, but without limitation, shares, foreign exchange contracts, commodities, debentures, derivatives, government bonds, investment fund quotas, investment certificates, among others.
(b) the quantity of each Instrument and/or Collateral of the portfolio, that is, the quantity of identical Instruments comprised within the portfolio considered;
(c) the maturity or settlement date of each Instrument and/or

Collateral. Having identified each type of Instrument comprised within the portfolio, it is also possible to identify the liquidation term of each Instrument or Collateral;
(d) the amount of which each Instrument is being negotiated and/or the amount pledged of each Collateral, that is, the present value of each Instrument or Collateral identified; and
(e) market capability of absorbing the Instrument's or Collateral liquidation, or the liquidity parameters of each Instrument or Collateral comprised within the portfolio. The liquidity or market absorption parameters can be defined, in short, by the market's ability to absorb a certain Instrument or Collateral, based on known statistical models.

The parameters such as (a) the type(s) of Instrument(s) and/or Collaterals; (b) the quantity of each Instrument and/or Collateral of the portfolio; (c) the maturity or settlement date of each Instrument and/or Collateral; and (d) the amount of which each Instrument is being negotiated and/or the amount pledged of each Collateral can be obtained from the position database (201) and/or the Collateral database (202) (depending whether the parameter is related to the Instrument or to the Collateral), since such parameters are intrinsic parameters related to an Instrument.

The market capability of absorbing the Instrument's or Collateral liquidation, or the liquidity parameters of each Instrument or Collateral comprised within the portfolio may be obtained from a risk database (203) which stores pre input parameters of the liquidity of an Instrument or Collateral.

Particularly, the strategy for closing out the portfolio of a Participant should be efficient in the sense that, on the one hand, it considers the set of restrictions imposed by the characteristics of its elements (the types of Instruments, quantity, maturity date, etc.) and, on the other hand, it minimizes losses during the closeout process.

Thus, the step of determining the closeout strategy can be represented by determining a matrix (XE) that presents, in its rows, the N Instruments, including the Collaterals, which should be liquidated and, in its columns, each time interval considered within a maximum term for closeout of the portfolio. Filling out the matrix will be the amount (q) of each Instrument therein which should be liquidated in each term considered. The amount (q) considered may be either a monetary amount or a physical amount. Preferably, the amount is a monetary amount. Still particularly, the time interval considered involves constant cycles, defined herein as uninterrupted and subsequent cycles, though they may also be represented as daily, hourly, weekly, monthly cycles etc.

Table I below represents a matrix (XE) for defining a closeout strategy of N Instruments considered within time intervals T₀ to Tₘₐₓ.

TABLE I

| | T₀ | T + 1 | T + 2 | - - - | Tₘₐₓ |
|---|---|---|---|---|---|
| Instrument₁ | q_{1, 0} | q_{1, 1} | q_{1, 2} | - - - | q_{1, Tmax} |
| Instrument₂ | q_{2, 0} | q_{2, 1} | q_{2, 2} | - - - | q_{2, Tmax} |
| - - - | - - - | - - - | - - - | - - - | - - - |
| Instrument_{N} | q_{N, 0} | q_{N, 1} | q_{N, 2} | - - - | q_{N, Tmax} |

In this table, each type of Instrument is represented in the rows of the matrix, whereas the time intervals (T) are represented in the columns of the matrix, considering a maximum closeout time (Tₘₐₓ). Accordingly, it can be perceived that, on the one hand, each of the Instruments are defined and grouped accordingly, for example, with the type of Instrument considered (Instrument₁ to Instrument_{N}). The amount of each Instrument depending on the maturity term or liquidation of the Instrument is filled out in the matrix (q_{1,0} to q_{N,Tmax}).

The step of defining the closeout strategy by determining a matrix as represented in table I above may be carried out by extracting the required data such as parameter (a) to (d) as mentioned above from the position (201) database related to the Instruments portfolio and extracting the parameters (a) to (d) as mentioned above from the Collateral database (202) and sending such parameters to a closeout strategy processor (301) which is operative to determine the closeout strategy by defining the matrix (XE).

The parameters related to the market capability of absorbing the Instruments may also be extracted from the risk database (203) which is operatively connected to the closeout strategy processor (301).

It will be appreciated that the position database (201), Collateral database (202), the risk database (203), the closeout strategy processor (301), the risk processor (302) as well as the other functionalities of the Exchange, may be implemented in hardware, software or a combination thereof, including in connection with embodiments of database management systems, financial information systems, and other data stores or systems. Further, the functionalities may be implemented in logic or computer program code stored in a memory and executable by one or more processors which may be directly or indirectly connected through a network for example. A hardware-implemented processor is a tangible unit capable of performing certain operations and may be configured or arranged in a certain manner. Such a hardware-implemented processor is permanently, temporarily, or transitorily configured (e.g., programmed) to operate in a certain manner and/or to perform certain operations. In the example embodiments, one or more computer systems (e.g., a standalone, client or server computer system) or one or more processors may be configured by software (e.g., an application or application portion) as a hardware-implemented processor that operates to perform certain operations as described herein.

The maximum time (Tₘₐₓ) considered for the closeout of the portfolio can conveniently be defined by the characteristics of the Instruments and/or Collaterals, such as the maturity of settlement date, or one which will perform the closeout of the portfolio, such as an Exchange, or else be considered as the last day that a position can be closed.

Next, a matrix can be generated containing the remaining balances (s) of each of the Instruments at each time interval considered T₀ to Tₘₐₓ, in accordance with Table II below:

TABLE II

| | T₀ | T + 1 | T + 2 | - - - | Tₘₐₓ |
|---|---|---|---|---|---|
| Instrument₁ | S_{1, 0} | S_{1, 1} | S_{1, 2} | - - - | S_{1, Tmax} |
| Instrument₂ | S_{2, 0} | S_{2, 1} | S_{2, 2} | - - - | S_{2, Tmax} |
| - - - | - - - | - - - | - - - | - - - | - - - |
| Instrument_{N} | S_{N, 0} | S_{N, 1} | S_{N, 2} | - - - | S_{N, Tmax} |

Accordingly, it is possible to form a relationship between the liquidated position of the Instruments at a given moment with the remaining balances, based upon, for example, the market capability of absorbing the Instruments or Collaterals. This relationship between the remaining balances of each Instrument and the position of the Instruments at a given time considered can be expressed by the following equation:

$${s}_{i , j} = {Π}_{i} - {\sum }_{m = 0}^{j} {q}_{i , m} \qquad Eq . 1$$

where s_{i,j} is the remaining balance of a given Instrument at a given fixed time; π represents the i-th initial position of the portfolio of Instruments and Collaterals considered, with 1≦i≦N Instruments or Collaterals, and 0≦j≦Tmax.

Therefore, it is possible to construct a mathematical representation of the closeout strategy, that is, determining an optimal matrix (XE), based on the optimization of the losses generated for the Participant and other arguments, as presented below:

$$CE ( Π ; Ψ ( Π ) ; Ω ( Π ) ) = XE \\ arg {min}_{XE} FC ( Ω ( Π ) ; XE ) \\ subject to Ψ ( Π ) \\ and {\sum }_{t = 0}^{t = TMAX} {q}_{i , t} = {Π}_{i} \qquad Eq . 2$$

where (CE) is the function for determining the closeout strategy of the portfolio; π is the portfolio of Instruments and/or Collaterals considered; ψ is the function of the restrictions associated to the portfolio of Instruments and Collaterals which includes one or more of parameters (a) to (e) listed above; Ω is the function of the scenarios associated to the portfolio; XE is the closeout strategy and FC is the loss function to be minimized.

The loss function (FC) of the equation 2 depends exclusively on the closeout strategy adopted and on the scenarios considered for each time period, as will be seen in below, since the main risk involved is the financial loss associated to adverse movement of the market.

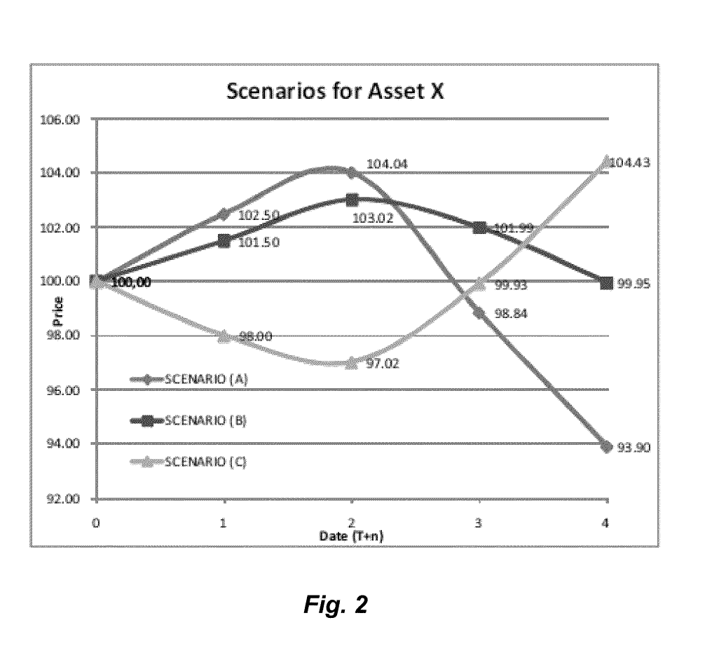

As stated previously, during the step of defining the closeout strategy of the portfolio of Instruments, the Collaterals portfolio may also be incorporated. The inclusion of the Collaterals allows the achievement of benefits associated to an even more optimized measure of the loss risks, such as, for example, the offset of exposure to common risk factors of the portfolio of Instruments and of the Collaterals portfolio of the Participant, and the greater acceptance of Instruments without immediate liquidity, depending on the characteristics of the portfolio of Instruments and Collaterals considered. In the first case, there is the advantage of recognizing opposite positions in terms of market risk between the portfolio of Instruments and the Collaterals portfolio. In the second case, a greater potential of acceptance of Instruments without immediate liquidity is due to the ability to identify correctly the periods in which any payment needs arise and their relationship to the minimum terms for monetization of each type of Collateral, such as exemplified in FIG. 2 and described above.

The step related to defining the closeout strategy, therefore, provides a vision of how liquidation of the portfolio considered will be carried out in a horizon of time and, accordingly, it contains the elements enabling an evaluation of the risk related to the strategy considered, in accordance with the next step.

Next is the risk assessment (operation 103) related to the closeout strategy considered in the prior operation. The risk assessment may consist of an estimate of which are the possible losses or gains relating to each period deemed for a set of scenarios associated to the financial variables analyzed. In this sense, the risk assessment step establishes all possible results within the time interval (T₀, Tₘₐₓ) considered. The risk calculation methodology may vary, depending on which is chosen in accordance with the standards and practices of the Exchange itself or, otherwise, in accordance with the Instrument(s) being considered for the risk assessment, and may consist of one or more from a historical simulation, stress scenarios, Monte Carlo simulation, etc. Therefore, the risk assessment may analyze the potential variation scenario of the value of each Instrument or Collateral, that is, generating statistical scenarios, based on known models, of the possible variation of the value of each Instrument or Collateral identified and comprised within the portfolio of the Participant based upon the closeout strategy.

Known models of risk assessment and risk factors may be provided for example by a risk database (203) which stores or may be fed with risk models and parameters for different Instruments.

Accordingly, it can be assumed that N scenarios (Ncen) will be constructed based on N relevant risk factors (Nfr). Thus, applying these scenario dynamics to the closeout strategy previously defined allows a payoff matrix to be constructed, that is:

CR(XE; Ω(Π))=XR Eq. 3

where CR is the function for determining the losses or gains; XE is the closeout strategy adopted; Ω is the function of the scenarios associated to the portfolio; π is the portfolio of Instruments and/or Collaterals considered and XR is the payoff matrix, which can be represented in accordance with Table III below:

TABLE III

| | T₀ | T + 1 | T + 2 | - - - | Tₘₐₓ |
|---|---|---|---|---|---|
| Scen₁ | v_{1, 0} | v_{1, 1} | v_{1, 2} | - - - | v_{1, Tmax} |
| Scen₂ | v_{2, 0} | v_{2, 1} | v_{2, 2} | - - - | v_{2, Tmax} |
| - - - | - - - | - - - | - - - | - - - | - - - |
| Scen_{N} | v_{N, 0} | v_{N, 1} | v_{N, 2} | - - - | v_{N, Tmax} |

In the matrix, all possible scenarios (Scen) for the time period considered are placed in the rows and, in the columns, each time period considered (T), with due regard for the maximum closeout time of the portfolio (Tₘₐₓ). The matrix is filled out with the potential values of losses and gains in each time period considered (v_{N,T}), wherein each element v_{i,j} of the matrix can be determined according to the equation:

$${v}_{i , j} = {\sum }_{m = 1}^{NAT} {V}_{m} ( {s}_{m , j} ; {q}_{m , j} ; Ω ( {Π}_{m} ; i ; j ) ) \qquad Eq . 4$$

where v_{i,j} represents the loss (v_{i,j}<0) or gain (v_{i,j}>0) associated to the i-th scenario in the j-th time period (T) considered, and Vₘ is the cash flow function associated to the maintenance (s_{m,j}) or liquidation (q_{m,j}) of the position of the m-th component of the portfolio of Instruments and Collaterals, π is the portfolio of Instruments and Collaterals considered and Ω is the function of the scenarios associated to the portfolio.

The step of estimating risk may be carried out by extracting the required data such as risk models factors for each Instrument of the portfolio from the risk database (203) and sending such parameters to a risk processor (302) which is operative to generate a matrix of all possible scenarios (Scen) for the time period considered based upon the closeout strategy which was previously defined by the closeout processor (301) that also feds the risk processor (302) with the closeout strategy. Although in this embodiment the closeout processor and the risk processor are represented as separate processors, it must be considered that both processors may be part of a single processing unit.

Next, the potential losses are determined (operation 104).

An efficient risk model according to the invention takes into consideration permanent and transient losses, and the permanent losses are calculated at the end of the process of closing out the portfolio, based on which it is established whether or not there is a deficit of funds or Collateral, and transient losses are noted whenever there is a temporary deficit of funds or Collateral during the process of closing out the portfolio.

The potential permanent loss associated to each of the scenarios determined by the risk analysis defined in the prior step is carried out by the algebraic sum of the losses and gains in each of the periods (T₀, Tₘₐₓ) considered, that is, the sum of the rows of each of the scenarios generated in the scenarios matrix, in accordance with Table III. The equation below lists the potential permanent loss for a given portfolio considered within a given

$${RP}_{i} = Min ( {\sum }_{j = 0}^{TMAX} {v}_{i , j} ; 0 ) \qquad Eq . 5$$

where RPᵢ is the permanent loss relating to the i-th scenario and represents the loss (v_{i,j}<0) or gain (v_{i,j}>0) associated to the i-th scenario in the j-th time period (T) considered.

Determining the potential transient loss, in turn, depends on the existence and on the rules of use of any liquidity mechanisms or financing model adopted, which can be determined within a portfolio closeout option or policy, or else by regulatory matters. Considering solely the greatest need for liquidity during the portfolio closeout period (T₀, Tₘₐₓ), it can be determined based on the difference between the estimated losses by way of a self-financeable model (which considers only ascending cash flows for purposes of deduction of a negative cash flow at instant T), and the estimated losses by way of a model with full financing. This value can be represented and calculated in accordance with the equation below:

$${ML}_{i} = Min ( {\sum }_{j = 0}^{TMAX} {v}_{i , j} ; 0 ) - Min ( \begin{matrix}0 ; {v}_{i , 0} ; {v}_{i , 1} + {v}_{i , 2} ; {v}_{i , 1} + \\ {v}_{i , 2} + {v}_{i , 3} ; … ; {\sum }_{j = 0}^{TMAX} {v}_{i , j}\end{matrix} ) \\ {ML}_{i} \geq 0 \qquad Eq . 6$$

where MLᵢ is the value of the greatest need for liquidity in the i-th scenario, the last term on the right-hand side of equation 6 represents the estimated losses based on a self-financeable model and the first term on the right-hand side of the equation 6 represents the estimated losses based on a full financing model. Thus, the potential transient loss (RT) is given by:

RTᵢ=−MLᵢ+Λ(MLᵢ) Eq. 7

where RTᵢ is the value of the potential transient loss in the i-th scenario, ML is defined as above and A is the function of the financing model adopted. The worst case is then given by the scenario that has the greatest aggregated potential loss, since both the potential permanent losses and the potential transient losses should be duly collateralized. Therefore:

CP(XR; Λ)=[RP; RT]

[RP; RT]=[RPᵢ; RTᵢ]| [symbol] Abs(RPⱼ+RTⱼ)>Abs(RPᵢ+RTᵢ)∀j≠i Eq. 8

The calculation of the losses may be carried out by an additional processor that may be associated with the risk processor by summing all the potential permanent and transient losses for the different given scenarios, and thus calculating the overall potential loss. The result of the potential losses calculated may be sent to a losses database (204) to store the records and/or consultation.

One process embodiment of the invention may also comprise a step of verifying whether the Collateral deposited is sufficient (operation 105), based on the calculation of potential permanent and transient losses by, for example, comparing the losses calculated and recorded in the losses database (204) with the Collaterals available for the Participant in the Collateral database (202). If it is established that the Collateral available is not sufficient for the closeout of the portfolio based on the strategy determined, a step of requesting full payment of the necessary Collateral can be introduced, based on the potential permanent and transient losses calculated.

Another process embodiment of the invention also pertains to a process for the closeout of a portfolio which, besides the steps defined above, also comprises the step of closing out the portfolio in accordance with the defined closeout strategy.

### Example

Aspects of the invention will now be described in relation to a non-limitative example which is solely intended to illustrate one embodiment of the invention in an instructive manner and does not impose any limitation of any nature.

According to this example, and according to one embodiment of the invention, the process begins with the identification of a portfolio which is desirable to be closed out. The portfolio is formed by the following Instruments and/or Collaterals, defined in Table IV:

TABLE IV

| | | | Minimum |
|---|---|---|---|
| | Exposure | Maturity date | CloseOut Term |
| Swap - PRE × DI | $10m | 252 | 15 |
| Swap - DOL × PRE | −$10m | 12 | 15 |
| Futures - DOLF | $15m | 252 | 2 |
| Option - OPIND_P | $50m | 63 | 2 |
| Option - OPIND_F | −$50m | 63 | 15 |

The Options OPIND_P and OPIND_F correspond, respectively, to a call listed option on the Ibovespa index and an over the counter option (OTC) having the same characteristics which are deep-in-the-money. The restrictions imposed by the maturity dates and by the minimum period for the closeout of the positions of the portfolio are:
the swap position—PRE×DI cannot be closed in less than 15 days;
the swap position—DOL×PRE will not be closed and will liquidate in 12 days;
the position in the futures contract—DOLF can be closed only after the 2^{nd} day;
the position in the option—OPIND_P can be closed only after the 2^{nd} day;
the position in the option—OPIND_F cannot be closed in less than 15 days; and
the whole portfolio should be closed within a maximum of 15 days (Tₘₐₓ).

Next, the closeout strategy of the portfolio is defined within a maximum horizon of 15 days, considering the interval of one day. In this sense, having identified the Instruments comprised within the portfolio, also in relation to the Collaterals, an XE matrix is generated in order to define a closeout strategy of the Instruments regarded within the time intervals T₀ to Tₘₐₓ, as it may be seen in the Table V:

TABLE V

| | t + 0 | t + 1 | t + 2 | . . . | t + 12 | . . . | t + 15 |
|---|---|---|---|---|---|---|---|
| PRE × DI | 0 | 0 | 0 | . . . | 0 | . . . | $10 m |
| DOL × | 0 | 0 | 0 | . . . | −$10 m | . . . | 0 |
| PRE | | | | | | | |
| DOLF | 0 | 0 | $5 m | . . . | $10 m | . . . | 0 |
| OPIND_P | 0 | 0 | 0 | . . . | 0 | . . . | $50 m |
| OPIND_F | 0 | 0 | 0 | . . . | 0 | . . . | −$50 m |

The strategy constructed aggregates symmetrical positions for closing out any unprotected positions as quickly as possible. In accordance with this example, $5 m in the futures contract DOLF in 2 days.

Next, it is the risk assessment related to the given closeout strategy. For example purposes, a simple set of scenarios will be considered, wherein each risk factor is independent and has just two dynamics: high and low, as depicted in the table VI below:

TABLE VI

| | DOL | | PRE 252 | | CUPOM 252 | | IND | |
|---|---|---|---|---|---|---|---|---|
| | LOW | HIGH | LOW | HIGH | LOW | HIGH | LOW | HIGH |
| t + 1 | −10.75% | +10.75% | −2.00% | +2.00% | −1.80% | +1.80% | −17.75% | +17.75% |
| t + 2 | −12.00% | +12.00% | −2.10% | +2.10% | −1.90% | +1.90% | −18.00% | +18.00% |
| t + 3 | −12.50% | +12.50% | −2.20% | +2.20% | −2.00% | +2.00% | −18.25% | +18.25% |
| t + 4 | −13.00% | +13.00% | −2.30% | +2.30% | −2.10% | +2.10% | −18.50% | +18.50% |
| t + 5 | −13.50% | +13.50% | −2.40% | +2.40% | −2.20% | +2.20% | −18.75% | +18.75% |
| t + 6 | −14.00% | +14.00% | −2.50% | +2.50% | −2.30% | +2.30% | −19.00% | +19.00% |
| t + 7 | −14.50% | +14.50% | −2.60% | +2.60% | −2.40% | +2.40% | −19.25% | +19.25% |
| t + 8 | −15.00% | +15.00% | −2.70% | +2.70% | −2.50% | +2.50% | −19.50% | +19.50% |
| t + 9 | −15.50% | +15.50% | −2.80% | +2.80% | −2.60% | +2.60% | −19.75% | +19.75% |
| t + 10 | −16.00% | +16.00% | −2.90% | +2.90% | −2.70% | +2.70% | −20.00% | +20.00% |
| t + 11 | −16.50% | +16.50% | −3.00% | +3.00% | −2.80% | +2.80% | −20.25% | +20.25% |
| t + 12 | −17.00% | +17.00% | −3.10% | +3.10% | −2.90% | +2.90% | −20.50% | +20.50% |
| t + 13 | −17.50% | +17.50% | −3.20% | +3.20% | −3.00% | +3.00% | −20.75% | +20.75% |
| t + 14 | −18.00% | +18.00% | −3.30% | +3.30% | −3.10% | +3.10% | −21.00% | +21.00% |
| t + 15 | −18.50% | +18.50% | −3.40% | +3.40% | −3.20% | +3.20% | −21.25% | +21.25% |

Applying these scenarios to the closeout strategy, jointly with selecting the worst possible combination, generates a payoff matrix, the results of which, expressed in thousands of $, are presented in the table below:

TABLE VII

| | | | DOL × | | | |
|---|---|---|---|---|---|---|
| | Total | PRE × DI | PRE | DOLF | OPIND_P | OPIND_F |
| t + 1 | −1,582.50 | 0.00 | 0.00 | −1,582.50 | 0.00 | 0.00 |
| t + 2 | −125.00 | 0.00 | 0.00 | −125.00 | 0.00 | 0.00 |
| t + 3 | −50.00 | 0.00 | 0.00 | −50.00 | 0.00 | 0.00 |
| t + 4 | −50.00 | 0.00 | 0.00 | −50.00 | 0.00 | 0.00 |
| t + 5 | −50.00 | 0.00 | 0.00 | −50.00 | 0.00 | 0.00 |
| t + 6 | −50.00 | 0.00 | 0.00 | −50.00 | 0.00 | 0.00 |
| t + 7 | −50.00 | 0.00 | 0.00 | −50.00 | 0.00 | 0.00 |
| t + 8 | −50.00 | 0.00 | 0.00 | −50.00 | 0.00 | 0.00 |
| t + 9 | −50.00 | 0.00 | 0.00 | −50.00 | 0.00 | 0.00 |
| t + 10 | −50.00 | 0.00 | 0.00 | −50.00 | 0.00 | 0.00 |
| t + 11 | −50.00 | 0.00 | 0.00 | −50.00 | 0.00 | 0.00 |
| t + 12 | 1,630.00 | 0.00 | 1,680.00 | −50.00 | 0.00 | 0.00 |
| t + 13 | 0.00 | 0.00 | 0.00 | 0.00 | 0.00 | 0.00 |
| t + 14 | 0.00 | 0.00 | 0.00 | 0.00 | 0.00 | 0.00 |
| t + 15 | −340.00 | −340.00 | 0.00 | 0.00 | 10,625.00 | −10,625.00 |

Thus, as can be seen in this case, the value of the worst potential permanent loss calculated in accordance with equation 5 is equal to $867,500. Presuming the non-existence of uncollateralized liquidity mechanisms (i.e. Λ(.)), the value of the potential worst transient loss calculated in accordance with equation 6 is equal to $1,290,000. Therefore:

### [RP; RT]=[867.500,00; 1.290.000,00]

Accordingly, the total value of the Collaterals to be allocated is equal to the sum of the worst potential permanent and transient losses, that is, $2,157,500, of which $1,290,000 will be employed in an exclusively transitory manner, and may be recovered after the end of the process of closing out the portfolio, if there are no other remaining debts. It can be perceived that the potential transient losses are mainly associated to the liquidation of the position of the futures dollar contracts and foreign exchange swap.

On the other hand, supposing the existence of an uncollateralized liquidity mechanism, for example, liquidity fund, the use of which, for example, is limited to $1,000,000 per Participant, the value of the worst potential transient loss would be equal to $290,000, resulting in a need to allocate Collaterals of $1,157,500.

Although the invention has been described in relation to its particular embodiments, based on the teachings set forth herein those skilled in the art may make changes and/or alterations or also widen the concepts described herein for other purposes not described herein. Therefore, the accompanying claims should be construed as encompassing all and any equivalents that fall within the ambit and spirit of the invention.

1. A process of risk assessment for the closeout of a portfolio, comprising:
identifying, from a database accessible by a risk assessment system, a portfolio to be closed out, the risk assessment system including hardware elements to implement a closeout strategy processor and a risk processor;
defining, with operations of the closeout strategy processor, a strategy for the closeout of the portfolio;
estimating, with operations of the risk processor, the risk related to the closeout strategy; and
determining, with the risk assessment system, potential losses for closing out the portfolio based on the estimated risk.

2. The process of claim 1, wherein identifying a portfolio comprises identifying a portfolio of Instruments and a portfolio of Collaterals associated to the portfolio of Instruments.

3. The process of claim 1, wherein defining the closeout strategy comprises selecting one or more parameters from among (a) a type of one or more Instruments or Collaterals of which the portfolio is comprised; (b) a quantity of each Instrument or Collaterals of the portfolio; (c) a maturity or settlement date of each Instrument and Collaterals; (d) an amount at which each Instrument or Collateral is being negotiated; and (e) a market ability to absorb each Instrument or Collateral.

4. The process of claim 1, wherein defining the closeout strategy comprises determining a matrix XE which includes in rows of the matrix the amount (q) of Instruments or Collateral that should be liquidated and, in columns of the matrix, each time interval (T) considered within a maximum term (Tₘₐₓ) for the closeout of the portfolio.

5. The process of claim 4, wherein defining the closeout strategy comprises additionally determining a matrix which exhibits remaining balances of each Instrument or Collateral at each time interval considered, in accordance with:
$${s}_{i , j} = {Π}_{i} - {\sum }_{m = 0}^{j} {q}_{i , m}$$
wherein s_{i,j} is the remaining balance of a given Instrument or Collateral at a given fixed time; π represents the i-th initial position of the portfolio considered, with 1≦i≦N Instruments and 0≦j≦Tmax.

6. The process of claim 5, wherein the time interval considered involves constant, hourly, daily, weekly or monthly cycles.

7. The process of claim 1, wherein estimating the risk comprises an estimate of possible losses or gains relating to each period considered for a set of associated scenarios.

8. The process of claim 7, wherein estimating the risk comprises a risk calculation methodology in accordance with a predefined model.

9. The process of claim 8, wherein estimating the risk comprises determining a payoff matrix, in accordance with:
CR(XE; Ω(Π))=XR
wherein CR is the function for determining the losses or gains; XE is the closeout strategy adopted; C) is the function of the scenarios associated to the portfolio; π is the portfolio considered and XR is the payoff matrix.

10. The process of claim 9, wherein the matrix XR is filled out with the potential values of losses and gains in each time period considered (V_{N,T}), wherein each loss or gain element (v_{i,j}) of the matrix can be determined in accordance with:
$${v}_{i , j} = {\sum }_{m = 1}^{NAT} {V}_{m} ( {s}_{m , j} ; {q}_{m , j} ; Ω ( {Π}_{m} ; i ; j ) )$$
wherein v_{i,j} represents the loss (v_{i,j}<0) or gain (v_{i,j}>0) associated to the i-th scenario in the j-th time period (T) considered, and Vₘ is the cash flow function associated to the maintenance (s_{m,j}) or liquidation (q_{m,j}) of the position of the m-th component of the portfolio.

11. The process of claim 1, wherein calculating potential losses comprises calculating the permanent losses.

12. The process of claim 11, wherein calculating the permanent losses is carried out by the algebraic sum of the losses and gains in each one of the time periods (T₀, Tₘₐₓ) considered, in accordance with:
$${RP}_{i} = Min ( {\sum }_{j = 0}^{TMAX} {v}_{i , j} ; 0 )$$
wherein RPᵢ is the risk associated to the permanent loss and v_{i,j} represents the loss (v_{i,j}<0) or gain (v_{i,j}>0) associated to the i-th scenario in the j-th time period (T) considered.

13. The process of claim 1, wherein determining potential losses comprises calculating transient losses.

14. The process of claim 13, wherein calculating the transient losses comprises considering the rules for using liquidity mechanisms, in accordance with:
$${ML}_{i} = Min ( {\sum }_{j = 0}^{TMAX} {v}_{i , j} ; 0 ) - Min ( \begin{matrix}0 ; {v}_{i , 0} ; {v}_{i , 1} + {v}_{i , 2} ; {v}_{i , 1} + \\ {v}_{i , 2} + {v}_{i , 3} ; … ; {\sum }_{j = 0}^{TMAX} {v}_{i , j}\end{matrix} )$$
$${ML}_{i} \geq 0$$
wherein MLᵢ is the value of the largest liquidity need, the last term on the right-hand side represents the estimated losses based on a self-financeable model and the first term on the right-hand side represents the estimated losses based on a full financing model.

15. The process of claim 14, wherein the potential transient loss is given by:
RTᵢ=−MLᵢ+Λ(MLᵢ)
wherein RTᵢ is the value of the potential transient loss, and Λ is the function of the financing model adopted.

16. The process of claim 1, wherein calculating the potential losses is the algebraic sum of the potential permanent and transient losses.

17. The process of claim 1, further comprising verifying whether Collateral deposited is sufficient, based on the calculation of the potential losses.

18. The process of claim 17, further comprising requesting additional Collateral, if it is verified that the existing Collateral is not sufficient.

19. The process of claim 1, further comprising:
closing out the portfolio based on the strategy defined with the operations of the closeout strategy processor.

20. A process for defining the closeout strategy of a portfolio, comprising:
identifying, with a risk assessment system, a portfolio to be closed out;
defining, with the risk assessment system, a strategy for the closeout of the portfolio;
wherein defining the strategy comprises selecting one or more parameters from among (a) a type of Instruments of which the portfolio is comprised; (b) a quantity of each Instrument of the portfolio; and (c) a maturity or settlement date of each Instrument; and
determining a matrix XE, with the risk assessment system, which includes in rows of the matrix the amount (q) of Instruments or Collateral that should be liquidated and, in columns of the matrix, each time interval (T) considered within a maximum term (Tₘₐₓ) for the closeout of the portfolio, based on the parameters associated;
wherein the risk assessment system includes hardware elements arranged to perform operations of the process.

21. The process of claim 20, wherein identifying a portfolio comprises identifying a portfolio of Instruments and a portfolio of Collaterals associated to the portfolio of Instruments.

22. A computer readable storage medium including instructions which when executed by one or more processors in a system cause the computing system to:
identify a portfolio to be closed out;
define a strategy for the closeout of the portfolio;
estimate the risk related to the closeout strategy; and
determine the potential losses for closing out the portfolio based on the estimated risk.

23. A risk management system, comprising hardware elements including:
an electronic data source operative to provide data for a portfolio;
a closeout strategy processor operative to determine a closeout strategy for the portfolio; and
a risk processor operative to generate possible scenarios for a time period based on the closeout strategy, and produce an efficient risk model from the possible scenarios for the time period.
